(19) United States
(12) Patent Application Publication
(10) Pub. No.: US 2019/0102812 A1
(43) Pub. Date: Apr. 4, 2019

(54) INTELLIGENT SPACE MANAGEMENT WITH AUTONOMOUS OCCUPANCY DETECTION

(71) Applicants: Michael E. Giorgi, Hudson, OH (US); Patrick M. Mause, Streetsboro, OH (US); Steven Rosen, Hunting Valley, OH (US)

(72) Inventors: Michael E. Giorgi, Hudson, OH (US); Patrick M. Mause, Streetsboro, OH (US); Steven Rosen, Hunting Valley, OH (US)

(21) Appl. No.: 16/151,396

(22) Filed: Oct. 4, 2018

Related U.S. Application Data
(60) Provisional application No. 62/568,290, filed on Oct. 4, 2017.

(51) Int. Cl. G06Q 30/02; G06Q 20/14; G06K 9/00; G06Q 20/10

(52) U.S. Cl. CPC G06Q 30/0284; G06Q 20/14; G06Q 20/102; G06K 9/00369; G06K 9/00778

(57) ABSTRACT

Techniques for autonomously managing an intelligent space are provided. In one example, a method is provided that can comprise detecting, by a system operatively coupled to a processor, a number of occupants located in a space for a period of time. The number of occupants can be an integer greater than zero. The method can also comprise associating, by the system, the number of occupants with an entity. Further, the method can comprise billing, by the system, the entity a cost based on the number of occupants.

### CROSS-REFERENCE TO RELATED APPLICATIONS

This application claims priority to U.S. Provisional Patent Application Ser. No. 62/568,290 filed on Oct. 4, 2017, entitled “INTELLIGENT SPACE MANAGEMENT WITH AUTONOMOUS OCCUPANCY DETECTION.” The entirety of the aforementioned application is incorporated by reference herein.

### TECHNICAL FIELD

The subject disclosure relates to intelligent space management, and more specifically, to managing a space based on autonomous occupancy detection using processing systems, computer-implemented methods, apparatuses and/or computer program products in conjunction with hardware and/or software.

### BACKGROUND ART

Various organizations rent spaces for events such as weddings, conventions, seminars, and/or the like. Often the cost for renting said spaces can be dependent on the number of occupants in the space that are attending the event. Conventional space management techniques typically rely on a renter to provide an occupancy estimate to the space provider prior to the event for billing purposes. However, the actual number of occupants attending the event can differ from the estimate. Thus, the cost of renting the space can be substantially greater than or less than what the renter should actually be charged.

Additionally, as different organizations rent the spaces, the conditions required for the space can change. For example, different events can require the space to exhibit different temperatures and/or lighting conditions. Conventional space management techniques rely on manual adjustment of the space's conditions, and thus are subject to human error and inaccuracy.

The various embodiments described herein can address the shortcomings discussed above with conventional space management techniques.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can autonomous detect one or more occupants of a room and bill one or more entities based on said detection are described.

According to an embodiment, a computer-implemented method is provided. The method can comprise detecting, by a system operatively coupled to a processor, a number of occupants located in a space for a period of time, wherein the number of occupants is an integer greater than zero. Also, the method can comprise associating, by the system, the number of occupants with an entity. Further, the method can comprise billing, by the system, the entity a cost based on the number of occupants.

According to another embodiment, a system is provided. The system can comprise a memory that stores computer executable components. The system can further comprise a processor, operably coupled to the memory, and that executes the computer executable components stored in the memory. The computer executable components can comprise a detection component that detects a plurality of occupants located in a space for a period of time. The computer executable components can also comprise an association component that associates a first occupant of the plurality of occupants with a first group and associates a second occupant of the plurality of occupants with a second group.

According to another embodiment, a computer program product for managing an intelligent space is provided. The computer program product can comprise a computer readable storage medium having program instructions embodied therewith. The program instructions can cause a processor to detect an occupant located in a space for a period of time, wherein the space is selected from a group consisting of a building structure, a room and a defined geographical boundary. Further, the program instructions can cause the processor to associate the occupant with an entity. Also, the program instructions can cause the processor to adjust a parameter of the space based on the entity.

### BRIEF DESCRIPTION OF THE DRAWINGS

FIG. 1 illustrates a block diagram of an example, non-limiting system that can facilitate management of an intelligent space by billing a client in accordance with one or more embodiments described herein.

FIG. 2 illustrates a block diagram of an example, non-limiting system that can facilitate management of an intelligent space by controlling the intelligent space's climate in accordance with one or more embodiments described herein.

FIG. 3 illustrates a block diagram of an example, non-limiting system that can facilitate management of an intelligent space by generating a model of the intelligent space in accordance with one or more embodiments described herein.

FIG. 4 illustrates a diagram of an example, non-limiting model regarding an intelligent space in accordance with one or more embodiments described herein.

FIG. 5 illustrates a block diagram of an example, non-limiting system comprising multiple servers that can facilitate management of an intelligent space in accordance with one or more embodiments described herein.

FIG. 6 illustrates a block diagram of an example, non-limiting system comprising multiple intelligent spaces that can facilitate management of the intelligent spaces in conjunction with each other and in accordance with one or more embodiments described herein.

FIG. 7 illustrates a flow chart of an example, non-limiting method that can facilitate management of an intelligent space by billing a client in accordance with one or more embodiments described herein.

FIG. 8 illustrates a flow chart of an example, non-limiting method that can facilitate management of an intelligent space by controlling the intelligent space's climate in accordance with one or more embodiments described herein.

FIG. 9 illustrates a flow chart of an example, non-limiting method that can facilitate management of an intelligent space by generating a model of the intelligent space in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Provided is a detailed description on cloud computing. The embodiments described herein can be implemented in conjunction with a cloud computer environment. However, it is to be understood that the embodiments described herein are also capable of being implemented in conjunction with any other type of computing environment.

Cloud computing can serve as a convenient and reliable technology for providing an entity with access to a shared pool of computer resources. For example, cloud computing technology can enable an entity to access various networks, servers, computerized devices, software applications, storage, and services comprising the cloud environment. Further, access to the computer resources in the cloud environment can be managed via minimal interaction between the entity and a service provider. In various embodiments, a cloud environment can comprise multiple characteristics, service models, and/or deployment models.

Example characteristics of a cloud environment can include, but are not limited to: on-demand self-service, broad network access, resource pooling, rapid elasticity, and/or measured service. On-demand self-service can enable an entity to unilaterally provision computer resources (e.g., server time and network storage) as need automatically and with or without requiring human interaction with a provider of the computer resources. Cloud computing can provide broad network access over one or more networks via standard mechanisms that are compatible with various client platforms (e.g., mobile devise, computers, and/or personal digital assistants (PDAs).

In various cloud computing embodiments, a service provider's computing resources can be pooled to facilitate serving multiple entities simultaneously and/or sequentially. Different physical and/or virtual resources can be dynamically assigned and/or reassigned to meet the entity's demands. As such, entities utilizing the cloud environment generally have no control or knowledge over the exact location of the pooled resources but may identify a location with a high level of abstraction (e.g., country, state, and/or datacenter).

Additionally, cloud computing capabilities can be rapidly and elastically provisioned. For example, said capabilities can be automatically provisioned to quickly scale out and rapidly scale in. For an entity consuming the services of the cloud environment, capabilities for provisioning can appear to appear vast and available in any desired quantity at any desired time. Cloud computing systems can also automatically control and optimize the use of computer resources by leveraging a metering capability at a level of abstraction in accordance with the type of service provided by the cloud environment (e.g., storage, processing, and/or bandwidth). Computer resources comprising the cloud environment can be monitored, controlled, and/or reported to provide transparency and/or accountability for a consuming entity and/or a provider of the cloud's services.

Example service models of cloud computing can include, but are not limited to: software as a service (SaaS), platform as a service (PaaS), and/or infrastructure as a service (IaaS). In SaaS models, a service provider can enable an entity to use one or more applications (e.g., created by the provider) operating in a cloud infrastructure. Further, an entity can access an application on the cloud environment via one or more client interfaces such as a web browser. In other words, an entity utilizing the application can readily access the application through multiple platforms without having to maintain the cloud infrastructure.

In PaaS models, an entity can deploy their own applications on a cloud environment using programming tools supplied and/or supported by the provider of the cloud infrastructure. In IaaS models, the cloud environment provisions computer resources (e.g., processing, networks, and/or storage) for an entity to utilize when operating arbitrary software such as operating systems and applications. Thus, in the PaaS and/or IaaS models, the entity does not have control over the underlying cloud structure, but can control subject applications (e.g., the operating system) and configurations (e.g., networks and firewalls).

Example deployment models of cloud computing can include, by are not limited to: private clouds, community clouds, public clouds, and/or hybrid clouds. A private cloud model can be operated for a specific entity while denying access/services to alternate parties. The cloud can be managed by the specific entity or a third party and can be located on the entity's premises or off the entities premises. A community cloud can be operated for a plurality of organizations that share a common interest and/or concern (e.g., common mission, common security requirements, common policy, and/or common compliance considerations). Like the private cloud, the community cloud can be managed by one or more of the plurality of organizations and/or a third party.

A public cloud can be operated for the general public and/or a large group of entities (e.g., an industry). Further, public clouds can be owned by an organization that sells cloud services. A hybrid cloud can be a cloud infrastructure comprising two or more different deployment models (e.g., a private cloud and a community cloud). The various deployment models in the hybrid cloud structure can remain unique entities but be bound together by standardized or proprietary technology that can facilitate data and/or application portability (e.g., cloud bursting).

A cloud computer environment can comprise one or more nodes, wherein each node can be a computerized device (e.g., a desktop computer, a laptop computer, a mobile device, a tablet, an automobile system, and/or the like) used by a consumer of cloud services. The nodes can be connected via one or more networks in order to facilitate communication between the nodes and access to the cloud environment. Further, the nodes can be physically and/or virtually grouped in one or more networks to enable one or more deployment models. One of the advantages of cloud computing is the ability to provide services to a consumer via a multitude of platforms without requiring the consumer to sustain and/or maintain computer resources on a specific device.

Various embodiments of the present invention can be directed to computer processing systems, computer-implemented methods, apparatus and/or computer program products that facilitate the efficient, effective, and autonomous (e.g., without direct human guidance) management of an intelligent space by: billing a client, controlling intelligent space's climate, and/or generating a model regarding the intelligent space. For example, one or more embodiments described herein can detect a number of occupants located in a subject intelligent space for a period of time, associate one or more detected occupants with a client, and bill the client based on the detected number of occupants and/or the client identity. Other embodiments described herein can detect a number of occupants located in a subject intelligent space for a period of time, associate one or more detected occupants with a client, and control the climate of the intelligent space based on detected number of occupants and/or the client identity. Additional embodiments described herein can detect a number of occupants located in a subject intelligent space for a period of time, associate one or more detected occupants with a client, and generate a model regarding the intelligent space based on at least the detected occupants.

The computer processing systems, computer-implemented methods, apparatus and/or computer program products employ hardware and/or software to solve problems that are highly technical in nature (e.g., managing an intelligent space based on at least autonomous occupancy detection), that are not abstract and cannot be performed as a set of mental acts by a human. For example, a human cannot detect and identify occupants located in a space with the same level of accuracy and efficiency achieved by the embodiments described herein. As a space increases in size and entry ways, it becomes increasing difficult for a human to detect occupants, identify said occupants, and track said occupants as described herein. Furthermore, a human cannot manage multiple rooms simultaneously as disclosed herein for a variety of reasons such as, but not limited to: each room can be too large for an individual human to manage, difficulties in communication can cause errors in the efforts of a group of humans to attempt to manage a plurality of rooms, and/or the rooms may be separated from each other over a vast distance. Additionally, a human cannot implement the billing features described herein as quickly, accurately, and efficiently as the various embodiments described herein.

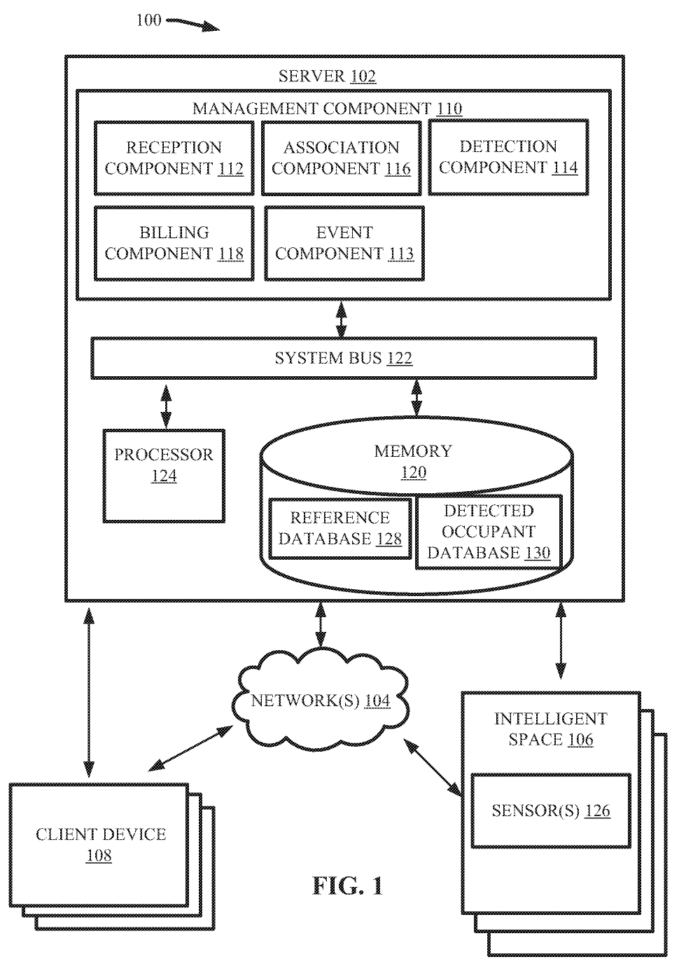

FIG. 1 illustrates a block diagram of an example, non-limiting system 100 that can facilitate management of one or more intelligent spaces. Aspects of systems (e.g., system 100 and the like), apparatuses or processes in various embodiments of the present invention can constitute one or more machine-executable components embodied within one or more machines, e.g., embodied in one or more computer readable mediums (or media) associated with one or more machines. Such components, when executed by the one or more machines, e.g., computers, computing devices, virtual machines, etc. can cause the machines to perform the operations described.

As shown in FIG. 1, the system 100 can comprise one or more servers 102, one or more networks 104, and/or intelligent spaces 106, and/or one or more client devices 108. The server 102 can comprise a management component 110. The management component 110 can further comprise a reception component 112, a detection component 114, an association component 116, and a billing component 118. Also, the server 102 can comprise or otherwise be associated with at least one memory 120. The server 102 can further comprise a system bus 122 that can couple to various components such as, but not limited to, the management component 110 and associated components, memory 120 and/or a processor 124. While a server 102 is illustrated in FIG. 1, in other embodiments, multiple devices of various types can be associated with or comprise the features shown in FIG. 1. Further, the server 102 can communicate with the cloud environment described herein.

The one or more networks 104 can comprise wired and wireless networks, including, but not limited to, a cellular network, a wide area network (WAN) (e.g., the Internet) or a local area network (LAN). For example, the server 102 can communicate with the one or more intelligent spaces 106 and/or the one or more client devices 108 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the management component 110 can be provided on the one or more servers 102, it should be appreciated that the architecture of system 100 is not so limited. For example, the management component 110, or one or more components of management component 110, can be located at another computer device, such as another server device, a client device, etc.

The intelligent space 106 can be defined by an indoor location and/or an outdoor location. Example, locations that can define the intelligent space 106 include, but are not limited to: a building (e.g., a commercial building, and/or a private building), a room, a convention center, a vehicle (e.g., a boat, an automobile, and/or an aircraft), a concert venue, a field, a lawn, and/or any location that can be identified by a geographical boundary (e.g., global positioning coordinates, landmarks, walls, and/or fences).

Further, the one or more intelligent spaces 106 can comprise one or more sensors 126. The one or more sensors 126 can be utilized in conjunction with the system 100 to detect and identify occupants located in the one or more intelligent spaces 106 for a period of time. Example equipment that can comprise the sensors 126 can include, but are not limited to: cameras, lasers, thermometers, pressure sensors, transmitters (e.g., to generate and/or receive a signal such as an RFID or cellular signal), and/or microphones. For instance, the sensors 126 can comprise one or more cameras capable of capturing images during the day, the night, and/or in various lighting conditions (e.g., low light and/or high light conditions). Further, the cameras can be configured to capture images using: the visible light spectrum (e.g., light generally visible to the human eye), infrared light (IR), radio waves, electromagnetic radiation, and/or thermal radiation. In various embodiments, the cameras can capture still images and/or video images of the landscape and/or occupants in an intelligent space 106. Also, in one or more embodiments the cameras can be configure to capture an image in a fixed view point or can be configured to have the capacity to move (e.g., rotate, move vertically, and/or change a viewing angle).

Various types of lasers, using visible or invisible light to the human eye, can measure one or more distances regarding the intelligent space 106. Also, the lasers can detect when an entity (e.g., an occupant) traverses a particular location. In one or more embodiments the lasers can be configure to project a laser beam in a fixed direction or can be configured to have the capacity to move (e.g., rotate, move vertically, and/or change a projection angle). One or more thermometers (e.g., digital and/or analog thermometers) can determine the temperature in one or more locations of the intelligent space 106. Pressure sensors can be activated when a certain amount of pressure applied to the sensors surpasses a predefined threshold. Microphones can detect and/or record noises (e.g., speech and/or footsteps) originating from within the intelligent space 106 and/or near the intelligent space 106.

In one or more embodiments, the one or more sensors 126 can comprise a plurality of different types of equipment. For example, the one or more sensors 126 can comprise any combination of the described cameras, lasers, thermometers, pressure sensors, and/or microphones. Further, the sensors 126 can comprise a plurality of one type of equipment and a different number of another type of equipment and/or the same number of another type of equipment. Additionally, the intelligent space 106 may comprise active and non-active sensors 126. In some embodiments, all of the one or more sensors 126 can be active and thereby sensing a parameter regarding the intellectual space 106. In other embodiments, only a portion of the one or more sensors 126 can be active and thereby sensing a parameter regarding the intellectual space 106. For example, the one or more sensors 126 can comprise three cameras, one microphone, and/or one thermometer, wherein all of the one or more sensors 126 are active. In another example, the one or more sensors 126 can comprise three cameras, one microphone, and/or one thermometer, wherein only the three cameras are active.

In various embodiments, the one or more sensors 126 can be located in one or more positions in the one or more intelligent spaces 106. The location of the one or more sensors 126 in the one or more intelligent spaces 106 can depend on the equipment type and/or purpose of the one or more sensors 126. For example, cameras can be located at elevated positions throughout the one or more intelligent spaces 106 to acquire advantageous and/or encompassing view points over the landscape of the one or more intelligent spaces 106 and/or occupants located in the one or more intelligent spaces 106. Further, a plurality of cameras can be positioned in an intelligent space 106 so as to provide overlapping fields of vision for the respective cameras in order to minimize locations in the intelligent space 106 that are unseen by the cameras.

Various lasers can be positioned throughout the one or more intelligent spaces 106 to detect the passage of an entity (e.g., an occupant) through an area. For example, one or more lasers can project beams across one or more walk-ways in the intelligent space 106. The lasers can be positioned in or near boundaries (e.g., walls) defining the intelligent space 106 and/or at entrance and/or exit paths to the intelligent space 106. The lasers can also be positioned at one or more heights and/or angles.

In various embodiments, the sensors 126 can comprise one or more pressure sensors can be positioned on the floor and/or integrated into the floor of the intelligent space 106. As one or more occupants walk on the one or more pressure sensors, the pressure sensors can be triggered thereby signaling the detection of one or more occupants.

Additionally, the sensors 126 can comprise one or more thermometers to sense the temperature of one or more locations in the intelligent space 106. The thermometers can be analog or digital. In some embodiments, the one or more thermometers can sense temperature in proximity the respective thermometer. In other embodiments, the one or more thermometers can sense temperature at distance from the respective thermometer (e.g., a distance greater than or equal to 5 feet and less than or equal to 100 feet from the respective thermometer).

In one or more embodiments, the sensors 126 can comprise one or more microphones. The microphones can be positioned in one or more locations in the intelligent space 106. In some embodiments one or more microphones can be positioned outside the intelligent space 106 and oriented to detect sound (e.g., footsteps and/or speech) originating from within the intelligent space 106.

The one or more intelligent spaces 106 can be operably coupled to the one or more servers 102 via one or more networks 104. Also, the one or more intelligent spaces 106 can be directly connected to the one or more servers 102.

The one or more client devices 108 can comprise one or more computers and/or computerized devices (e.g., a processor, a microprocessor, and/or storage capacity devices). Example client devices 108 can include, but are not limited to: a desktop computer, a laptop computer, a mobile device (e.g., a smart phone), a tablet, and/or a smart wearable (e.g., a smart watch). In various embodiments, the one or more client devices 108 can also comprise one or more program accounts (e.g., an account with a service provider via a cloud environment). The one or more client devices 108 can receive one or more event settings from an entity interested in occupying the intelligent space 106. Further, the client device 108 can facilitate billing an entity associated with occupants identified in the intelligent space 106, as described below. For example, the one or more client devices 108 can receive one or more invoices from the one or more servers 102. In another example, the one or more client devices 108 can directly access one or more financial institutions related to one or more entities associated with occupants located in the one or more intelligent spaces 106 and directly withdraw funds to pay for said occupation of the one or more intelligent spaces 106. In various embodiments, the one or more client devices 108 can further transmit one or more signals to one or more sensors 126 to facilitate detection and/or identification of one or more occupants located in one or more of the intelligent spaces 106 during a period of time.

The one or more client devices 108 can be operably coupled to the one or more servers 102 via one or more networks 104. Also, the one or more client devices 108 can be directly connected to the one or more servers 102.

In various embodiments, the reception component 112 can receive one more signals from the one or more intelligent spaces 106. The one or more signals can depict the observations detected by the one or more sensors 126. In other words, the one or more intelligent spaces 106 can send information detected by the one or more sensors 126 to the reception component 112. For example, the one or more intelligent spaces 106 can send one or more images captured by one or more sensors 126 (e.g., one or more cameras) as signals to the reception component 112. The one or more signals can comprise information detected by the one or more sensors 126 such as, but not limited to: one or more images captured by one or more cameras, one or more laser beam interruptions detected by one or more lasers, one or more temperatures sensed by one or more thermometers, one or more pressure triggers detected by one or more pressure sensors, one or more sounds detected by one or more microphones, and/or one or more transmissions detected by one or more transmitters.

In various embodiments, the reception component 112 can be operably coupled to the one or more intelligent spaces 106 and or the one or more client devices 108 via one or more networks 104. In some embodiments, the reception component 112 can be directly coupled to the one or more intelligent spaces 106 and/or the one or more client devices 108. Further, the reception component 112 can be operably coupled to the event component 113 via the one or more networks 104. Also, the reception component 112 can be directly coupled to the event component 113.

The event component 113 can create one or more events to be held at the one or more intelligent spaces 106. As used herein, the term “event” can refer to any planned gathering of people at the one or more intelligent spaces 106. Example, events can include, but are not limited to: a wedding, a birthday, a wake, a seminar, an exhibition, a sporting event, a workplace, and/or the like. The event component 113 can receive one or more event settings (e.g., via the reception component 112) from an operator of the server 102 and/or one or more of the client devices 108. The event settings can regard information relating to one or more events. Example event settings can include, but are not limited to: the type of subject event, the location of a subject event, the time of a subject event, the duration of a subject event (e.g., a period of time), desired climate conditions (e.g., humidity and/or temperature) for the one or more intelligent spaces 106 during a subject event, desired lighting conditions for one or more intelligent spaces 106 during a subject event, the type and/or number of sensors 126 that will be active during a subject event, and/or music to be played during the event. In one or more embodiments, the event component 113 can activate or deactivate one or more sensors 126 of a subject intelligent space 106 based on the event settings regarding an event being held at the subject intelligent space 106.

The reception component 112 can further be operably coupled to the detection component 114 via the one or more networks 104. Also, the reception component 112 can be directly coupled to the detection component 114. Further, while FIG. 1 illustrates the detection component 114 located on the server 102, the detection component 114 can also be located in and/or near the one or more intelligent spaces 106.

The detection component 114 can analyze the one or more signals received by the reception component 112 to determine whether or not one or more occupants have been detected by the one or more sensors 126. For example, the detection component 114 can use machine learning artificial intelligence techniques to recognize one or more occupants. In various embodiments, the detection component 114 can determine the presence of an occupant located in the intelligent space 106 without determining the identity of the occupant. In one or more embodiments, the detection component 114 can determine both the presence of an occupant located in the intelligent space 106 and the identity of the occupant. For example, the detection component 114 can use one or more machine learning techniques to determine that an object in one or more images captured by the sensors 126 is an occupant and further use facial recognition techniques on the determined occupant to determine the identity of the occupant. For instance, a reference database 128 comprising images of potential occupants can be stored in the memory 120 and used as a comparison by the detection component 114 for the facial recognition techniques.

Once the detection component 114 determines that an occupant has been detected in the one or more intelligent spaces 106, the detection component 114 can create one or more detected occupants databases 130 by saving one or more characteristics of the detected occupant in the memory 120. One or more detected occupants databases 130 can be created for each event created by the event component 113. The detected occupants database 130 can comprise one or more characteristics of a detected occupant along with a catalog number associated with each detected occupant. Example characteristics of a detected occupant that can comprise the detected occupants database 130 by the detection component 114 can include, but are not limited to: the stature of a subject detected occupant, the clothing of a subject detected occupant, a height of a subject detected occupant, a facial image of a subject detected occupant, and/or an identification beacon associated with a subject detected occupant (e.g., a name tag worn by the subject detected occupant and/or a signal, such as RFID, Bluetooth, WiFi, and/or the like, emitted by a device worn and/or carried by the subject detected occupant, such as a client device 108).

FIG. 1 illustrates the memory 120, the reference database 128, and the detected occupants database 130 as located on the server 102; however, in various embodiments the memory 120, the reference database 128, and/or the detected occupants database 130 can be located outside the server 102. For example, one or all of the memory 120, the reference database 128, and/or the detected occupants database 130 can be located on the client device 108, the network 104 (e.g., via a cloud environment), and/or the intelligent space 106.

As one or more occupants are detected by the detection component 114 during an event, the detection component 114 can compare the one or more detected occupants with occupants previously detected during the event and saved in the detected occupants database 130. Thus, the detection component 114 can determine whether a detected occupant has already been detected in association with an event and thereby prevent saving duplicate detected occupants in the detected occupants database 130.

In various embodiments, the detection component 114 can control the one or more sensors 126 to detect one or more occupants. For example, the detection component 114 can coordinate the one or more sensors 126 to detect one or more occupants, identify one or more characteristics of one or more detected occupants, and/or identify one or more detected occupants. In one or more embodiments, observations made by one sensor 126 can be validated and/or supported by observations made by another sensor 126. For instance, one type of sensor 126 (e.g., a laser, a thermometer, a pressure sensor, a microphone, and/or a transmitter) can determine the presence of an occupant based on a trigger (e.g., an interruption in a laser beam, a change in temperature, a change in pressure, the detection of a sound, and/or the detection of a beacon such as an electromagnetic wave). In response to the trigger, the detection component 114 can control another sensor 126 (e.g., a camera) to gather additional data regarding the occupant that triggered the one or more of the sensors 126 (e.g., capture an image of the location of the laser beam interruption at the time of the laser beam interruption). In other words, a combination of multiple sensors 126 and types of sensors 126 can be utilized by the detection component 114 to detect the presence of an occupant, conduct observations regarding the detected occupant, and/or identify the detected occupant.

The association component 116 can associate one or more detected occupants comprising the detected occupants database 130 with one or more entities. In one or more embodiments, the association component 116 can associate all the occupants detected by the detection component 114 and stored in the detected occupants database 130 with a single entity. In various embodiments, one or more occupants detected by the detection component 114 and stored in the detected occupants database 130 can be associated with a first entity while another one or more occupants detected by the detection component 114 and stored in the detected occupants database 130 can be associated with a second entity. In some embodiments, one or more occupants detected by the detection component 114 and stored in the detected occupants database 130 can be associated with a plurality of entities. In other words, the association component 116 can associate: one or more occupants comprising a detected occupants database 130 with a single entity; a first portion of the occupants comprising a detected occupants database 130 with a first entity and a second portion of the occupants comprising the detected occupants database 130 with a second entity; and/or an occupant comprising a detected occupants database 130 with a plurality of entities.

The association component 116 can associate one or more detected occupants with an entity based on the one or more characteristics attributed to the one or more detected occupants and stored in the detected occupants database 130. As described above, the one or more characteristics can comprise observations and/or measurements determined by the detection component 114. For example, the association component 116 can associate a detected occupant with an entity based on, but not limited to: a determined identity (e.g., via facial recognition), an identification symbol, and/or an identification beacon.

In various embodiments, the association component 116 can associate one or more detected occupants of the detected occupants database 130 with one or more entities based on the identity of the subject occupant determined by the detection component 114. For example, wherein the detection component 114 can use facial recognition techniques to determine an occupant's identity via a comparison of images captured by the one or more sensors 126 and the reference database 128, the association component 116 can associate the subject occupant to one or more entities based on the determined identity. In another example, the detection component 114 can determine the identity of a subject occupant based on an identification badge (e.g., a name tag) worn by the occupant, and the association component 116 can associate the determined identity with one or more entities.

In various embodiments, the association component 116 can associate one or more detected occupants of the detected occupants database 130 with one or more entities based on an identification symbol detected by the detection component 114 and stored as a characteristic. For example, an identification symbol can include, but is not limited to: a color of an identification badge and/or shape of an identification badge. For instance, one or more identification symbols can be made available to occupants as they enter the intelligent space 106, and the occupants can wear or otherwise display said identification symbols as they traverse the intelligent space 106. The detection component 114, via the one or more sensors 126, can detect said identification symbols and store them as characteristics relating to occupants as said occupants are detected. In one example, the identification symbol can be a colored sticker (e.g., a blue sticker), the colored sticker can be worn by members of a particular entity when they are located within the intelligent space 106, and the detection component 114 can detect the presence of an occupant and identify the occurrence of the colored sticker displayed by the subject occupant as a characteristic. The association component 116 can then associate one or more occupants in the detected occupants database 130 with one or more entities based on the identification symbol (e.g., detected occupants with the characteristic of having a blue sticker are associated with a first entity while detected occupants with the characteristic of having a red sticker, or not colored sticker at all, are associated with a second entity).

In one or more embodiments, the association component 114 can associate one or more detected occupants of the detected occupants database 130 with one or more entities based on an identification beacon. The identification beacon can be a communication between a client device 108 and the one or more sensors 126 (e.g., a receiver/transmitter), and said communication can comprise, but is not limited to: a radio wave, and electromagnetic wave, a Bluetooth connection, and/or a wireless connection (e.g., a local area network). For example, a client device 108 (e.g., a smart phone) can connect to one or more sensors 126 via one or more networks 104 (e.g., a local area network connection) in response to the client device 108 entering a subject intelligent space 106. The detection component 114 can denote one or more established connections between a client device 108 and a sensor 126 as a characteristic in a detected occupants database 130.

In another example, the identification beacon can comprise an RFID chip worn and/or carried by an occupant upon entering a subject intelligent space 106. The RFID chip can establish a connection with one or more sensors 126 (e.g., RFID transmitter/receiver), the detection component 114 can utilize said connection to detect the presence of an occupant within the intelligent space 106, and the association component 116 can utilize said connection to associate the detected occupant with an entity. Further, one of ordinary skill in the art will readily recognize that the embodiments described herein are not limited to connections established by local area networks and/or RFID technology. Connections between an identification beacon (e.g., a client device 106 such as a smart phone) and a sensor 126 can be established via a multitude of wireless technologies (e.g., Bluetooth, a software application, ZigBee, a personal area network, a metropolitan area network, WiFi, WiMAX, a wide area network, and/or a long-term evolution (LTE) connection).

In various embodiments, the association component 116 enables detected occupants to be associated with one or more entities to facilitate one or more goals (e.g., accurate billing). For example, the association component 116 can associate one or more detected occupants with a service entity present to cater and otherwise service an event hosted in the intelligent space 106. Thus, the management component 110, via the detection component 114 and/or the association component 116, can determined which detected occupants should be considered with regard to billing conditions for a subject entity (e.g., which detected occupants are participants of a subject event and associated with a subject billing entity, and which detected occupants are not participants of a subject event and/or are not associated with a subject billing entity).

In another example, the detection component 114 and/or association component 116 can facilitate management of any event attended by multiple billing entities. For example, an event can be co-hosted in a subject intelligent space 106 by two or more entities. Further, each entity can be billed based on which occupants attending the event were invited by the subject entity. For instance, wherein 100 occupants are detected in the intelligent space 106 (e.g., via the detection component 114 and the one or more sensors 126), 60 of the detected occupants could have been invited by a first entity and thereby associated with the first entity (e.g., via the association component 116) in conjunction with one or more goals (e.g., for billing purposes that can be performed by the billing component 118 as described later herein). Additionally, 30 of the detected occupants could have been invited by a second entity and thereby associated with the second entity (e.g., via the association component 116) in conjunction with one or more goals (e.g., for billing purposes that can be performed by the billing component 118 as described later herein). Further, the remaining 10 detected occupants can be service staff and thereby associated with a third entity (e.g., via the association component 116) in conjunction with one or more goals (e.g., for billing purposes that can be performed by the billing component 118 as described later herein). Thus, the embodiments described herein can advantageously detect and associate multiple groups within an event hosted in the intelligent space 106.

In various embodiments, the billing component 118 can generate one or more invoices and send said invoices to one or more subject entities in regards to occupants detected within the intelligent space 106 during an event and associated with the entity. In one or more embodiments, the billing component 118 can communicate with one or more client devices 108 operated by a subject entity to be billed in regards to the intelligent space 106 (e.g., with regard to one or more detected occupants). The billing component 118 can communicate with the one or more client devices 108 via the one or more networks 104 and/or via direct coupling. In one or more embodiments, the billing component 118 can bill an entity (e.g., via generating a billing invoice) via one or more accounts managed by the subject entity through the one or more networks 104 (e.g., through a cloud environment). The one or more accounts can be provided by: an operator of the system 100, an entity subject to billing, and/or a third party. The billing invoice can include information relating to: an event hosted in the intelligent space 106, a number of occupants detected in the intelligent space 106 during the event and associated with a subject entity, one or more occupant identities determined by the management component 110, and/or any rates and/or conditions a subject entity has incurred as a result of the detected occupants associated with the entity for the event.

FIG. 1 illustrates the billing component 118 located on the server 102; however, in various embodiments the billing component 118 can be located outside the server 102 and communicate with the server 102 and the server's 102 components (e.g., via the one or more networks 104). For example, in one or more embodiments the billing component 118 can be located on the client device 108, the network 104, and/or the intelligent space 106.

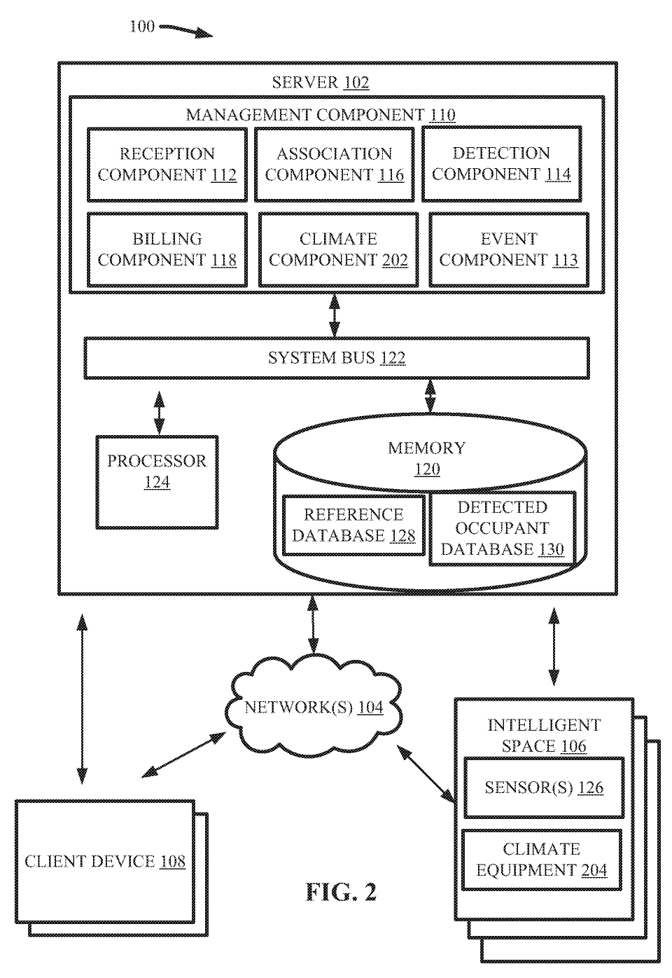

FIG. 2 illustrates a block diagram of an exemplary, non-limiting, embodiment of the system 100 further comprising a climate component 202 and climate equipment 204. Repetitive description of like elements employed in other embodiments described herein is omitted for sake of brevity. In various embodiments, in addition to the billing features described herein, or in the alternative, the management component 110 can control the climate of the intelligent space 106 based on at least, but not limited to: the number of detected occupants and/or the identify of detected occupants (e.g., via the detection component 114, the reference database 128, and/or the detected occupants database 130), characteristics of the detected occupants (e.g., via the detection component), associations of the detected occupants to one or more entities (e.g., via the association component), and/or one or more event settings (e.g., via the event component 113).

In one or more embodiments, the climate component 202 can control the climate of the intelligent space 106 by manipulating climate equipment 204 located in the intelligent space 106. Climate equipment 204 can comprise one or more devices that can control one or more features regarding the climate and/or environment of a subject intelligent space 106. Example climate equipment 204 can include, but is not limited to: lights, thermostats, air conditioners, stereo devices (e.g., receivers, microphones, and/or speakers), computers, automated doors (e.g., doors that can be controlled and/or assisted by a computerized device), and/or automated windows (e.g., doors that can be controlled and/or assisted by a computerized device). As described herein with regard to the one or more sensors 126, the climate equipment 204 can comprise a single type of device (e.g., a thermostat for controlling the temperature of the intelligent space 106) or a plurality of various types of devices (e.g., a thermostat for controlling the temperature of the intelligent space 106 and lights for controlling lighting conditions within the intelligent space 106). The climate component 202 can control the climate equipment 204 (e.g., one or more automatic doors) to adjust the number of entrances and/or exits of the intelligent space 106 based on the number of detected occupants.

The climate component 202 can control the climate equipment 204 to meet one or more parameters designated by one or more event settings received by the event component 113. The climate component 202 can determine when a subject event is being hosted in the intelligent space 106 and control the climate equipment 204 to create conditions in the intelligent space 106 that meet one or more event settings. The climate component 202 can determine a subject event is being hosted in an intelligent space based on, but not limited to: one or more event settings (e.g., a date and/or time of the event) and/or one or more associations determined by the association component 116 (e.g., determining that one or more detected occupants are associated with an entity scheduled to host a subject event). For instance, the management component 110 (e.g., via the detection component 114 and/or the association component 116) can determine that one or more occupants associated with an entity scheduled to host an event in the intelligent space 106 (e.g., via the event component 113) are detected in the intelligent space 106, and the climate component 202 can manipulate the climate equipment 204 (e.g., a thermostat and stereo devices) to meet one or more event settings associated with the scheduled event (e.g., keeping a temperature of the intelligent space 106 at 72 degrees Fahrenheit and playing a predetermined musical playlist).

In some embodiments, the climate component 202 can control the climate equipment 204 based on one or more observations and/or measurements made by the one or more sensors 126. For example, wherein an event setting indicates that the intelligent space 106 should be kept at a temperature of 72 degrees Fahrenheit and a sensor 126 determines the temperature of the intelligent space to be 78 degrees Fahrenheit, the climate component 202 can control the climate equipment 204 to lower the temperature of the intelligent space 106 to meet the conditions designated by the event settings. In another example, the climate component 202 can control climate equipment 204 to meet one or more general conditions that can be applicable to all events hosted in the intelligent space 106, unless otherwise specified by the event settings.

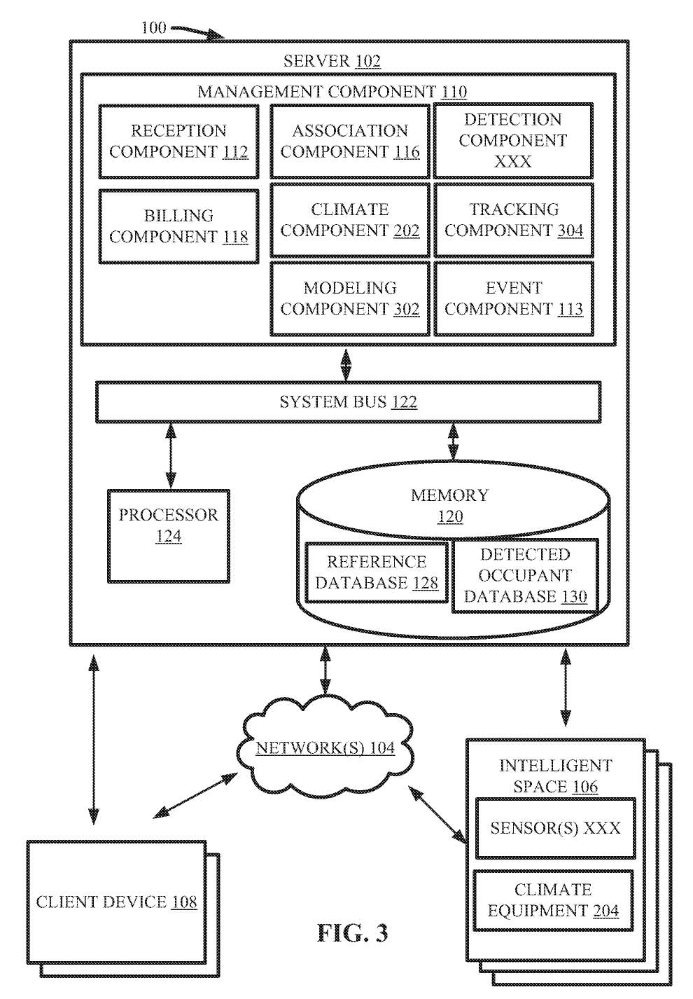

FIG. 3 illustrates a block diagram of an exemplary, non-limiting, embodiment of the system 100 further comprising modeling component 302 and tracking component 304. Repetitive description of like elements employed in other embodiments described herein is omitted for sake of brevity. In various embodiments, in addition to the billing features and/or climate control features described herein, or in the alternative, the management component 110 can further generate one or more models based on one or more determinations of the sensors 126, detection component 114, and/or association component 116. The one or more models can illustrate one or more parameters of the intelligent space 106 such as, but not limited to: observations and/or measurements made by the sensors 126, detections determined by the detection component 114, and/or associations determined by the association component 116.

For example, the modeling component 302 can generate one or more models that illustrate the number of detected occupants (e.g., as detected by the detection component 114), the identity of detected occupants (e.g., as determined by the detection component 114 and/or the association component 116), the time each detected occupant entered the intelligent space 106 (e.g., via the one or more sensors 126), and/or the entrance used by a subject detected occupant to enter the intelligent space 106 (e.g., via the sensors 126 and/or the detection component 114). In another example, the modeling component 302 can generate one or more models that illustrate one or more observations and/or measurements made by the sensors 126 over a period of time (e.g., changes in temperature of a period of time, changes in lighting conditions over a period of time, and/or changes in population density over a period of time).

Further, the tracking component 304 can facilitate the modeling component 302 by aggregating the observations, determinations, measurements, and/or settings received and/or produced by the system 100. In various embodiments, the tracking component 304 can track one or more detected occupants as the occupants traverse a subject intelligent space 106. For example, the tracking component 304 can aggregate images captured by one or more sensors 126 to track the location of a detected occupant throughout the intelligent space 106. In another example, the tracking component 304 can aggregated signals received from identification beacons by one or more sensors 126 to track the location of a detected occupant throughout the intelligent space 106.

In one or more embodiments, the tracking component 304 can also track one or more observations and/or measurements made by the one or more sensors 126. For example, the tracking component 304 can track temperature changes throughout the intelligent space over a period of time (e.g., via one or more thermometers comprising the sensors 126). In another example, the tracking component 304 can track air flow patterns through the intelligent space over a period of time (e.g., via one or more sensors 126 configured to measure fluid pressure such as a barometer).

The modeling component 302 can further store the one or more generated models on the memory 120 and/or send the one or more generated models to a client device 108 (e.g., via the one or more networks 104). The generated models can be utilized to identify patterns in the operation of the intelligent space 106 to optimize efficiency.

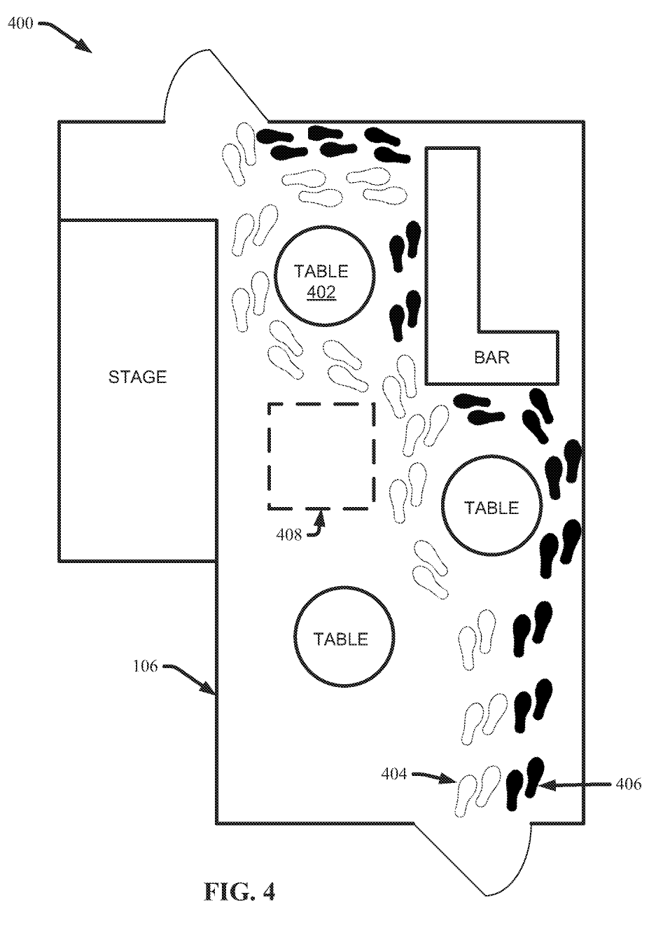

FIG. 4 illustrates an exemplary, non-limiting, model 400 that can be generated by the modeling component 302. Repetitive description of like elements employed in other embodiments described herein is omitted for sake of brevity. The model 400 illustrates an intelligent space 106 comprising a stage, a bar, two entrances/exits, and a plurality of tables such as table 402. Further, the model 400 shows the routes taken by a first detected occupant 404 (represented by white footprints) and a second detected occupant 406 (represented as black footprints) as both occupants traversed the intelligent space 106 for a period of time (e.g., the duration of an event). As can be seen from the model 400, the positioning of table 402 in relation to the stage and the bar created a congestion of foot traffic and limited access to the bar. Also, while model 400 only regards two detected occupants, one of ordinary skill in the art can readily recognize that a model comprising additional detected occupants is also envisaged.

Based on the model 400, showing foot traffic throughout the intelligent space 106, an entity using the system 100 can determine a furniture arrangement that optimizes available area of the intelligent space 106. In some embodiments, the model 400 can further suggest such space optimizing arrangements. For example, model 400 illustrates a designated area 408 into which the table 402 can be moved in order optimize available space. While model 400 illustrates foot traffic as a parameter of the intelligent space 106, one of ordinary skill in the art can readily recognize that models regarding other parameters captured and/or determined by the system 100 can be utilized by the modeling component 302 to generate similar models.

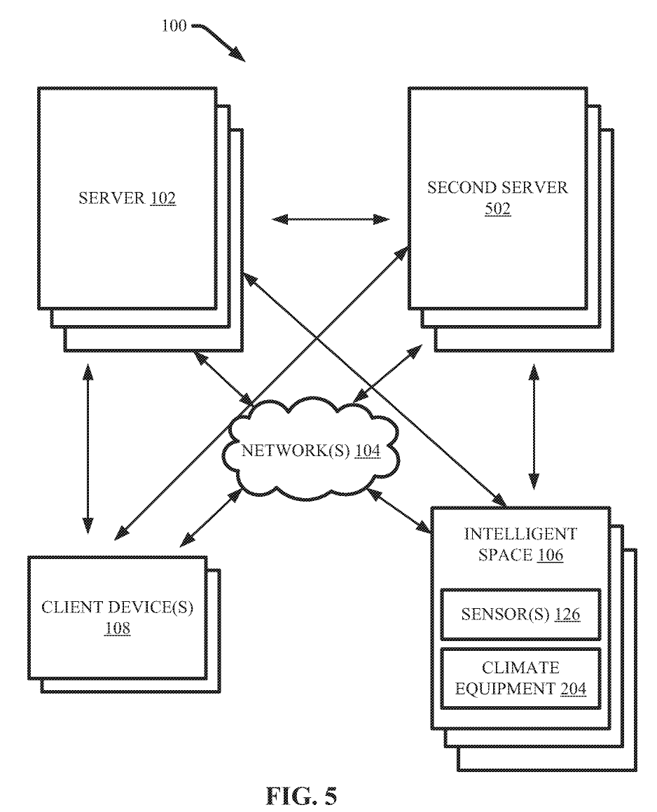

FIG. 5 illustrates a block diagram of the example, non-limiting, system 100 comprising a second server 502. Repetitive description of like elements employed in other embodiments described herein is omitted for sake of brevity. The second server 502 can comprise equivalent components as those described herein with regards to server 102 and perform equivalent functions as those described herein with regards to server 102.

The second server 502 can be operably coupled to the server 102 directly or via one or more networks 104. Further, the second server 502 can be operably coupled to one or more client devices 108 directly or via one or more networks 104. Also, the second server 502 can be operably coupled to one or more intelligent spaces 106 directly or via one or more networks 104. For example, the second server 502 can access and utilize (e.g., via a cloud environment) the reference database 128, the detected occupants database, and/or stored models generated by the server 102.

In some embodiments, each intelligent space 106 can be managed by a respective server (e.g., server 102 or second server 502). In one or more embodiments, a subject intelligent space 106 can be managed multiple servers (e.g., by server 102 and second server 502 or by server 102 and then second server 502).

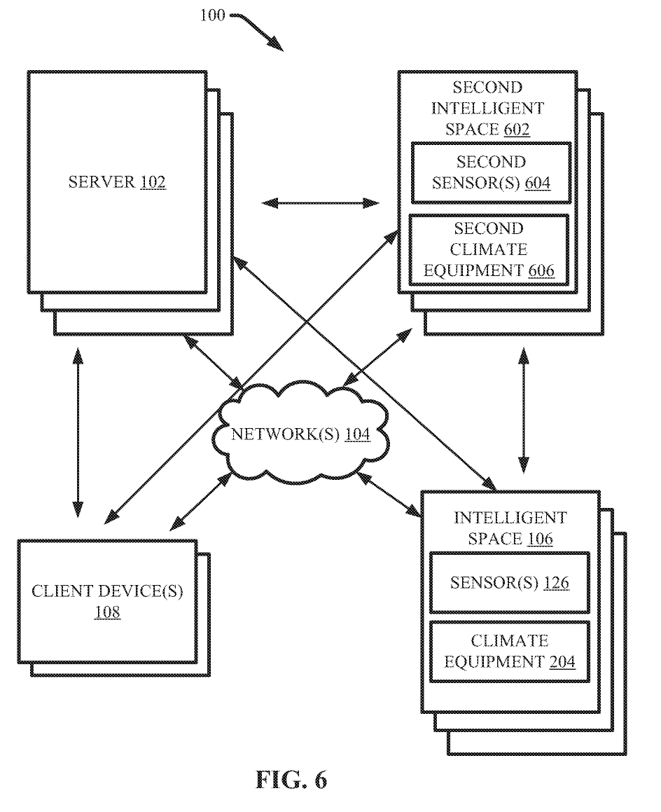

FIG. 6 illustrates a block diagram of the example, non-limiting, system 100 comprising a second intelligent space 602. Repetitive description of like elements employed in other embodiments described herein is omitted for sake of brevity. The second intelligent space 602 can comprise equivalent components as those described herein with regards to intelligent space 106 and perform equivalent functions as those described herein with regards to intelligent space 106. For example, the second intelligent space 602 can comprise one or more second sensors 604 equivalent to the sensors 126 described herein. Further, the second intelligent space 602 can comprise second climate equipment 606 equivalent to the climate equipment 204 described herein.

The second intelligent space 602 can be operably coupled to one or more servers (e.g. server 102 and/or second server 502) directly or via one or more networks 104. Further, the second intelligent space 602 can be operably coupled to one or more client devices 108 directly or via one or more networks 104. Also, the second intelligent space 602 can be operably coupled to the intelligent space 106 directly or via one or more networks 104.

In some embodiments, the intelligent space 108 and the second intelligent space 602 can be managed by the server 102 simultaneously, whereupon the management component 110 receives observations and/or measurements from both the sensors 126 and the second sensors 604. The detection component 114 can detect one or more occupants in both the intelligent space 106 and the second intelligent space 602. Also, the detection component 114 can compare the characteristics of all detected occupants (e.g., from intelligent space 106 and second intelligent space 602) in a generated detected occupants database 130 to ensure an occupant is not entered into the detected occupants database 130 twice by traveling from the intelligent space 106 to the second intelligent space 602. Thus, the detection component 114 can generate a detected occupants database 130 comprising occupants from both the intelligent space 106 and the second intelligent space 602, which can server as a basis for the associations determined by the association component 116. The billing component 118 can generate one or more invoices based on the occupancy of both the intelligent space 106 and the second intelligent space 602. The tracking component 304 can track one or more parameters regarding the intelligent space 106 separate from parameters regarding the second intelligent space 602, or the tracking component 304 can track one or more parameters regarding the intelligent space 106 and the second intelligent space 602 in combination. Also, the modeling component 302 can generate one or more models based on parameters of both the intelligent space 106 and the second intelligent space 602.

In various embodiments, the management component 110 can control the climate of both the intelligent space 106 and the second intelligent space 602. For example, the climate component 202 can control the second climate equipment 606 to manipulate one or more conditions of the second intelligent space 602 to meet one or more event settings.

As shown in FIG. 6, by incorporating multiple intelligent spaces (e.g., intelligent space 106 and second intelligent space 602) into the system 100, the management component 110 can monitor, control, and model multiple locations simultaneously. In various embodiments, the system 100 can facilitate hosting a single event across multiple intelligent spaces. In some embodiments, the system 100 can facilitate managing multiple intelligent spaces simultaneously with each intelligent space hosting a respective event. For example, large convention centers can be divided into multiple intelligent spaces with each space designated for a separate entity and/or event, wherein the management component 110 can manage each space simultaneously.

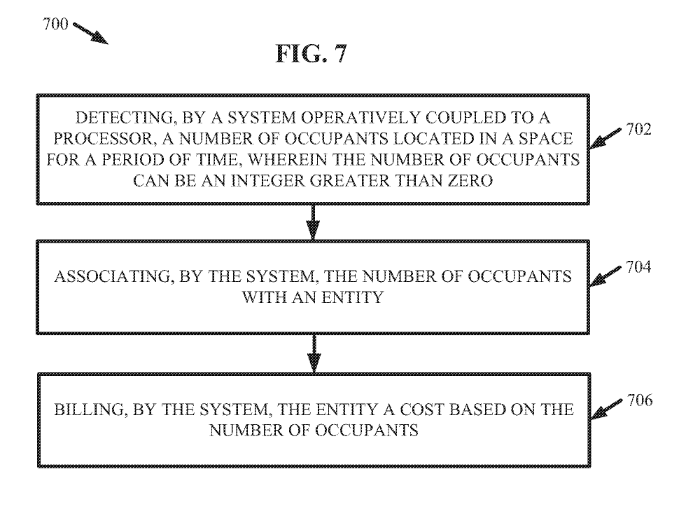

FIG. 7 illustrates a flow diagram of an example, non-limiting method 700 for managing an intelligent space 106 for billing purposes. Repetitive description of like elements employed in other embodiments described herein is omitted for sake of brevity. At 702, the method 700 can comprise detecting, by a system 100 operatively coupled to a processor 124, a number of occupants located in a space (e.g., the intelligent space 106) for a period of time (e.g., via the detection component 114 and/or the sensors 126), wherein the number of occupants is an integer greater than zero. At 704, the method 700 can further comprise associating, by the system 100, the number of occupants with an entity (e.g., via the association component 116). Also, at 704 the method 700 can comprise billing, by the system 100, the entity a cost (e.g., via the billing component 118) based on the number of occupants.

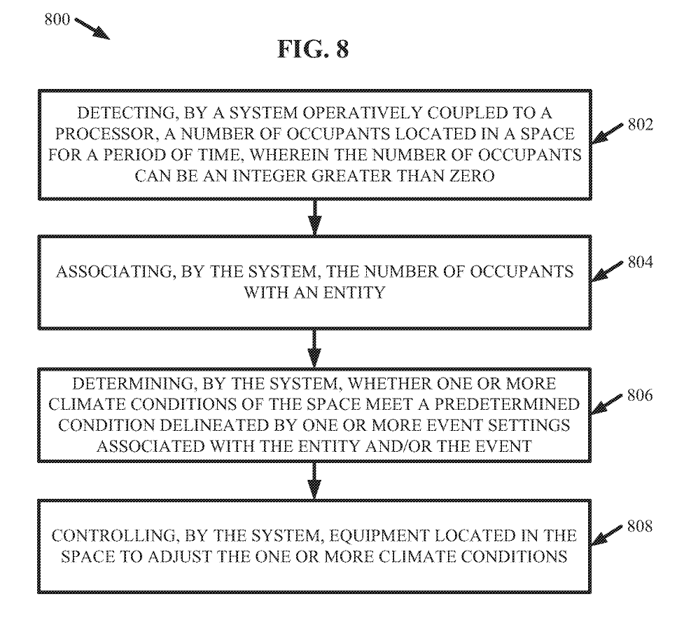

FIG. 8 illustrates a flow diagram of an example, non-limiting method 800 to control the climate of an intelligent space 106. Repetitive description of like elements employed in other embodiments described herein is omitted for sake of brevity. At 802, the method 800 can comprise detecting, by a system 100 operatively coupled to a processor 124, a number of occupants located in a space (e.g., the intelligent space 106) for a period of time (e.g., via the detection component 114 and/or the sensors 126), wherein the number of occupants is an integer greater than zero. At 804, the method 800 can further comprise associating, by the system 100, the number of occupants with an entity and/or an event (e.g., via the association component 116). At 806, the method 800, can comprise determining whether one or more climate conditions of the space (e.g., intelligent space 106) meet predetermined conditions delineated by one or more event settings associated with the entity and/or the event (e.g., via the climate component 202 and/or the event component 113). At 808, the method 800, can also comprise controlling, by the system, equipment (e.g., climate equipment 204) located in the space to adjust the one or more climate conditions (e.g., via the climate component 202).

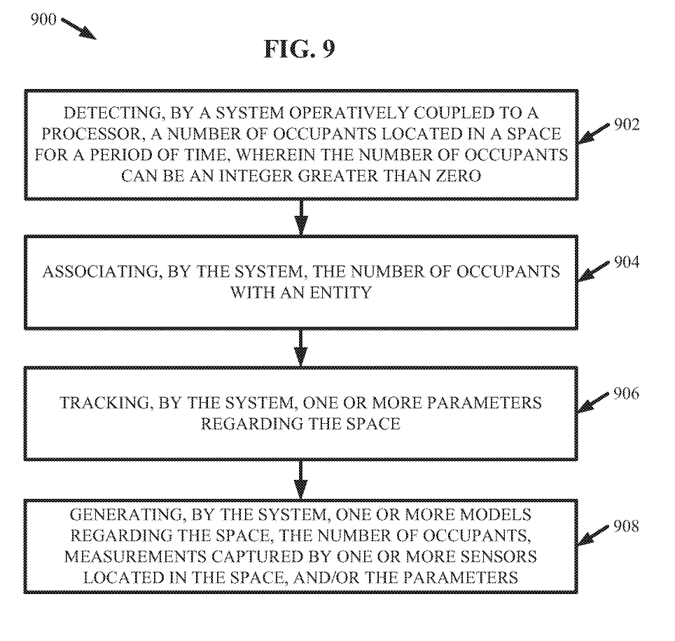

FIG. 9 illustrates a flow diagram of an example, non-limiting method 900 to model one or more parameters of an intelligent space 106. Repetitive description of like elements employed in other embodiments described herein is omitted for sake of brevity. At 902, the method 900 can comprise detecting, by a system 100 operatively coupled to a processor 124, a number of occupants located in a space (e.g., the intelligent space 106) for a period of time (e.g., via the detection component 114 and/or the sensors 126), wherein the number of occupants is an integer greater than zero. At 904, the method 900 can further comprise associating, by the system 100, the number of occupants with an entity and/or an event (e.g., via the association component 116). At 906, the method 900 can comprise tracking, by the system, one or more parameters regarding the space. For example, the one or more parameters can regard the number of occupants and/or measurements captured by one or more sensors (e.g., sensors 126) located in the space. At 908, the method 900 can also comprise generating, by the system, one or more models regarding the space, the number of occupants, the measurements captured by the one or more sensors, and/or the parameters.

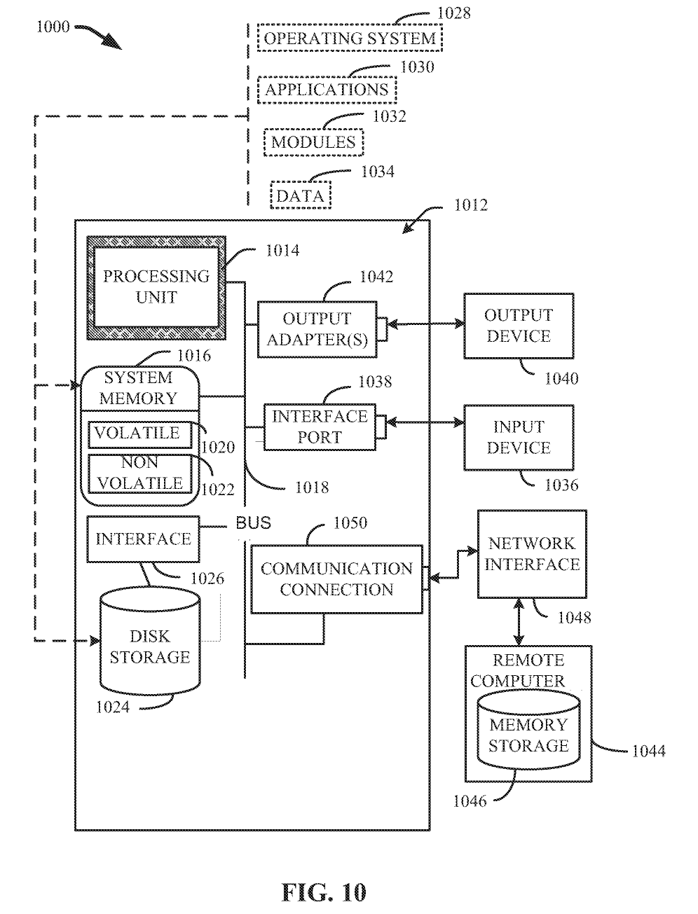

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity. With reference to FIG. 10, a suitable operating environment 1000 for implementing various aspects of this disclosure can include a computer 1012. The computer 1012 can also include a processing unit 1014, a system memory 1016, and a system bus 1018. The system bus 1018 can operably couple system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structures including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire, and Small Computer Systems Interface (SCSI). The system memory 1016 can also include volatile memory 1020 and nonvolatile memory 1022. The basic input/output system (BIOS), containing the basic routines to transfer information between elements within the computer 1012, such as during start-up, can be stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface can be used, such as interface 1026. FIG. 10 also depicts software that can act as an intermediary between users and the basic computer resources described in the suitable operating environment 1000. Such software can also include, for example, an operating system 1028. Operating system 1028, which can be stored on disk storage 1024, acts to control and allocate resources of the computer 1012. System applications 1030 can take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through one or more input devices 1036. Input devices 1036 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 1014 through the system bus 1018 via one or more interface ports 1038. The one or more Interface ports 1038 can include, for example, a serial port, a parallel port, a game port, and a universal serial bus (USB). One or more output devices 1040 can use some of the same type of ports as input device 1036. Thus, for example, a USB port can be used to provide input to computer 1012, and to output information from computer 1012 to an output device 1040. Output adapter 1042 can be provided to illustrate that there are some output devices 1040 like monitors, speakers, and printers, among other output devices 1040, which require special adapters. The output adapters 1042 can include, by way of illustration and not limitation, video and sound cards that provide a means of connection between the output device 1040 and the system bus 1018. It should be noted that other devices and/or systems of devices provide both input and output capabilities such as one or more remote computers 1044.

Computer 1012 can operate in a networked environment using logical connections to one or more remote computers, such as remote computer 1044. The remote computer 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer 1044. Remote computer 1044 can be logically connected to computer 1012 through a network interface 1048 and then physically connected via communication connection 1050. Further, operation can be distributed across multiple (local and remote) systems. Network interface 1048 can encompass wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). One or more communication connections 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components including a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting, by a system operatively coupled to a processor, a number of occupants located in a space for a period of time, wherein the number of occupants is an integer greater than zero;
associating, by the system, the number of occupants with an entity; and
billing, by the system, the entity a cost based on the number of occupants.

2. The computer-implemented method of claim 1, wherein the billing is further based on the entity.

3. The computer-implemented method of claim 1, wherein the space is selected from a group consisting of a building structure, a room, and a defined geographical boundary.

4. The computer-implemented method of claim 1, further comprising controlling a parameter of the space based on a variable selected from a group consisting of the number of occupants and the entity.

5. The computer-implemented method of claim 4, wherein the parameter is selected from a second group consisting of a temperature of the space, a humidity of the space, a lighting condition of the space, and music in the space.

6. The computer-implemented method of claim 3, wherein the billing is performed via a cloud environment.

7. The computer-implemented method of claim 3, wherein the system comprises a sensor selected from a second group consisting of a camera, a laser, a microphone, a pressure sensor, and a thermometer.

8. The computer-implemented method of claim 3, further comprising:
detecting, by the system, a second number of occupants located in the space for the period of time, wherein the second number of occupants is another integer greater than zero;
associating, by the system, the second number of occupants with a second entity; and
billing, by the system, the second entity another cost based on the second number of occupants.

9. The computer-implemented method of claim 8, wherein a sum of the number of occupants and the second number of occupants is a total number of occupants located in the space for the period of time.

10. The computer-implemented method of claim 3, wherein the associating is performed based on a color coded beacon, a first color being indicative of the entity.

11. A system, comprising:
a memory that stores computer executable components;
a processor, operably coupled to the memory, and that executes the computer executable components stored in the memory, wherein the computer executable components comprise:
a detection component that detects a plurality of occupants located in a space for a period of time; and
an association component that associates a first occupant of the plurality of occupants with a first group and associates a second occupant of the plurality of occupants with a second group.

12. The system of claim 11, wherein the space is selected from a third group consisting of a building structure, a room, and a defined geographical boundary.

13. The system of claim 12, further comprising a counting component that determines a first total number of occupants associated with the first group by the association component and determines a second total number of occupants associated with the second group by the association component.

14. The system of claim 13, further comprising a billing component that bills the first group based on the first total number of occupants and bills the second group based on the second total number of occupants.

15. The system of claim 12, wherein the association component associates the first occupant and the second occupant based on a beacon.

16. The system of claim 15, wherein the beacon is color coded, a first color being indicative of the first group, and a second color being indicative of the second group.

17. The system of claim 15, wherein the beacon transmits a signal to the detection component.

18. A computer program product for managing an intelligent space, the computer program product comprising a computer readable storage medium having program instructions embodied therewith, the program instructions executable by a processor to cause the processor to:
detect an occupant located in a space for a period of time, wherein the space is selected from a group consisting of a building structure, a room and a defined geographical boundary;
associate the occupant with an entity; and
adjust a parameter of the space based on the entity.

19. The computer program product of claim 18, wherein the program instructions further cause the processor to generate a model based on a variable selected from a second group consisting of the occupant and the entity.

20. The computer program product of claim 18, wherein the parameter is selected from a second group consisting of a temperature of the space, a lighting condition of the space and a number of entrances to the intelligent space.
